(19) United States
(12) Patent Application Publication
(10) Pub. No.: US 2018/0330693 A1
(43) Pub. Date: Nov. 15, 2018

(54) DISPLAY CORRECTION APPARATUS

(71) Applicant: DENSO CORPORATION, Kariya-city, Aichi-pref. (JP)

(72) Inventor: Youichi NARUSE, Kariya-city (JP)

(21) Appl. No.: 15/777,236

(22) PCT Filed: Oct. 4, 2016
(86) PCT No.: PCT/JP2016/079375

§ 371 Date: May 18, 2018

(30) Foreign Application Priority Data
Nov. 27, 2015 (JP) 2015-231755

(51) Int. Cl. G09G 5/00; G06K 9/00

(52) U.S. Cl. CPC G09G 5/003; G06K 9/00604

(57) ABSTRACT

A display correction apparatus includes: a viewing acquisition unit acquiring a viewing direction of a user; a reference display unit displaying a reference display object; a comparison display unit displaying multiple comparison display objects having different positions each other in one direction, the comparison display unit being configured so that a specific display object having the same position in the one direction as the reference display object when there is no tilt and/or distortion is included; an instruction unit that instructs so that the display object among the comparison display objects; a selection unit selecting the comparison display object that is present in the viewing direction; and a correction unit that corrects the display so that the position of the specific display object in the one direction becomes the position of the comparison display object selected.

### CROSS REFERENCE TO RELATED APPLICATION

The present application is based on Japanese Patent Application No. 2015-231755 filed on Nov. 27, 2015, the disclosure of which is incorporated herein by reference.

### TECHNICAL FIELD

The present disclosure relates to a display correction apparatus.

### BACKGROUND ART

As a display apparatus displaying information to a driver in a vehicle, a head-up display has been known. As a patent literature disclosing the head-up display, Patent Literature 1 is disclosed. A variation of a dimension of a component configuring the head-up display, a variation generated by assembling, a backlash in installing the head-up display to the vehicle or the like sometimes may cause a tilt or a distortion.

### PRIOR ART LITERATURE

### Patent Literature

Patent Literature 1: JP 2014-199385 A

### SUMMARY OF INVENTION

Conventionally, a user is difficult to correct a tilt or a distortion. It is an object of the present disclosure to provide a display correction apparatus that enables the user to easily correct the tilt or the distortion of a display of a display apparatus.

According to one aspect of the present disclosure, a display correction apparatus corrects a tilt and/or a distortion of a display in a display apparatus. The display correction apparatus includes: a viewing acquisition unit that acquires a viewing direction of a user; a reference display unit that displays a reference display object in the display apparatus; and a comparison display unit that displays a plurality of comparison display objects differently positioned each other in one direction either of a longitudinal direction or a transverse direction. The comparison display objects include a specific display object that is positioned in a same position as the reference display object in the one direction when the tilt and/or the distortion does not exist.

The display correction apparatus further includes: an instruction unit that instructs the user to view a particular comparison display object of the comparison display objects that is positioned in a same position in the one direction as the reference display object; a selection unit that selects from the comparison display objects, a comparison display object existing in the viewing direction acquired by the viewing acquisition unit, when the instruction unit performs instruction; and a correction unit that corrects the display so that a position of the specific display object becomes a position of the comparison display object selected by the selection unit in the one direction.

According to the display correction apparatus, it may be possible for a user to easily correct the tilt and/or the distortion in the display of the display apparatus.

The display correction apparatus may be possible to acquire a viewing direction of the user and perform a correction by using the viewing direction. The user may not necessarily perform the correction by a manual operation. The display correction apparatus may be possible to perform the correction while keeping a position of an eye of the user at a position in driving a subject vehicle. That is, the position of the eye of the user is hard to change in performing the correction and in driving the subject vehicle. Therefore, it may be possible to more accurately correct the display of the display apparatus.

### BRIEF DESCRIPTION OF DRAWINGS

The above and other aspects, features and advantages of the present disclosure will become more apparent from the following detailed description made with reference to the accompanying drawings. In the drawings:

FIG. 1 is a block diagram showing a configuration of a display correction apparatus;

FIG. 2 is a block diagram showing a functional element of the display correction apparatus;

FIG. 3 is an explanatory view illustrating a positional relation of members installed to a subject vehicle;

FIG. 4 is an explanatory view illustrating a positional relation of members installed to the subject vehicle;

FIG. 5 is a flow chart showing a process executed by the display correction apparatus;

FIG. 6 is a flow chart showing a calibration process executed by the display correction apparatus;

FIG. 7 is an explanatory view showing a calibration display object and a pupil and a Purkinje image at when a driver views the calibration display object;

FIG. 8 is an explanatory view showing a reference display object and a comparison display object;

FIG. 9 is an explanatory view showing a reference display object and a comparison display object;

FIG. 10 is an explanatory view showing a reference display object and a comparison display object;

FIG. 11 is an explanatory view showing a reference display object and a comparison display object;

FIG. 12 is an explanatory view showing a reference display object and a comparison display object; and

FIG. 13 is an explanatory view showing a reference display object and a comparison display object.

### DESCRIPTION OF EMBODIMENTS

An embodiment of the present disclosure will be explained based on drawings.

### First Embodiment

1. Configuration of a Display Correction Apparatus 1

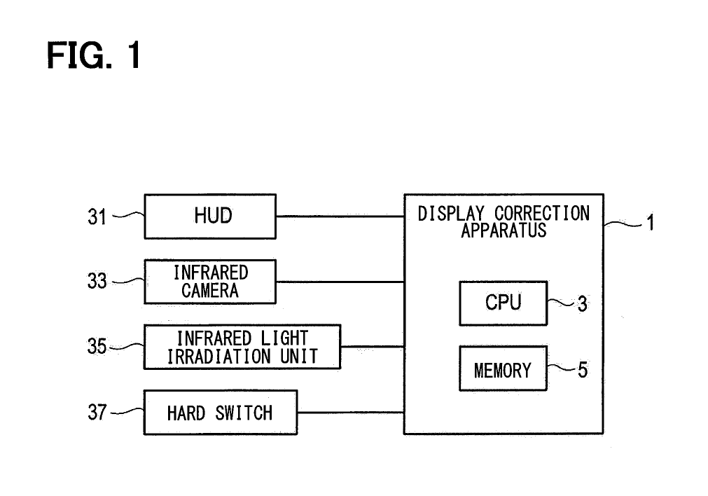

A configuration of a display correction apparatus 1 will be explained based on FIGS. 1 to 4. A display correction apparatus 1 is an onboard apparatus installed to a vehicle. Hereinafter, a vehicle to which the display correction apparatus 1 is installed may be referred to as a subject vehicle.

The display correction apparatus 1 is mainly configured by a known microcomputer including a CPU 3 and a semiconductor memory (hereinafter, referred to as a memory 5) such as a RAM, a ROM and a flash memory. The CPU 3 operates a program stored in a non-transitory tangible storage medium, so that a variety of the function of the display correction apparatus 1 is implemented. In the example, the memory 5 corresponds to the non-transitory tangible storage medium storing a program. An execution of the program causes to perform a method corresponding to the program. The number of the microcomputer configuring the display correction apparatus 1 may be one or more.

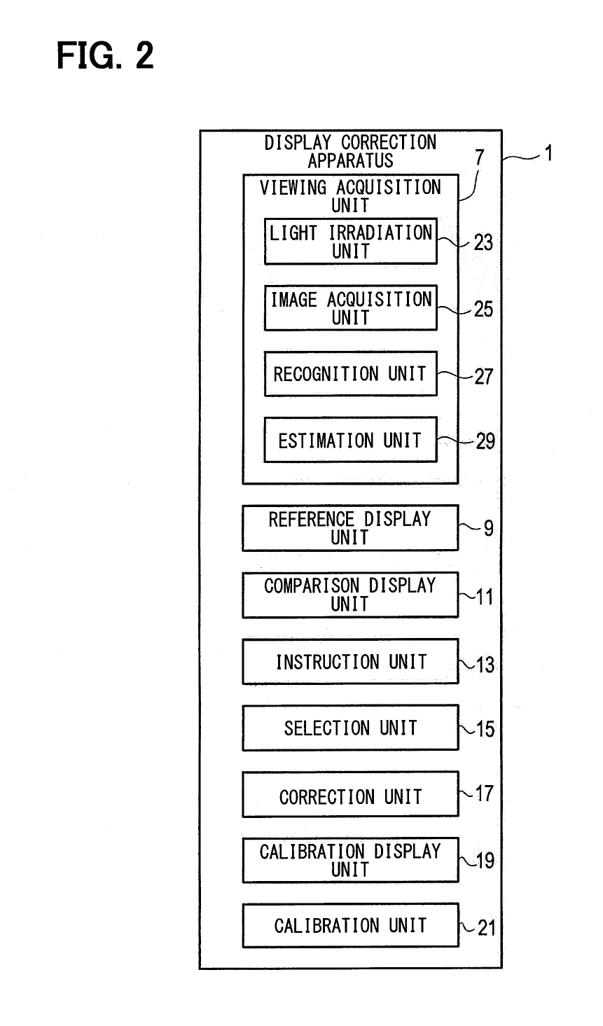

As a functional element implemented by the CPU 3 executing the program, as shown in FIG. 2, the display correction apparatus 1 includes a viewing acquisition unit 7, a reference display unit 9, a comparison display unit 11, an instruction unit 13, a selection unit 15, a correction unit 17, a calibration display unit 19 and a calibration unit 21. The viewing acquisition unit 7 includes a light irradiation unit 23, an image acquisition unit 25, a recognition unit 27 and an estimation unit 29.

A method implementing these elements configuring the display correction apparatus 1 is not limited to software. All or a part of elements may be implemented by using a hardware provided by combining a logic circuit or an analog circuit or the like.

The subject vehicle includes, in addition to the display correction apparatus 1, a head-up display 31, an infrared camera 33, an infrared light irradiation unit 35 and the hard switch 37. Hereinafter, the head-up display 31 may be referred to as a HUD 31. The HUD 31 corresponds to a display apparatus.

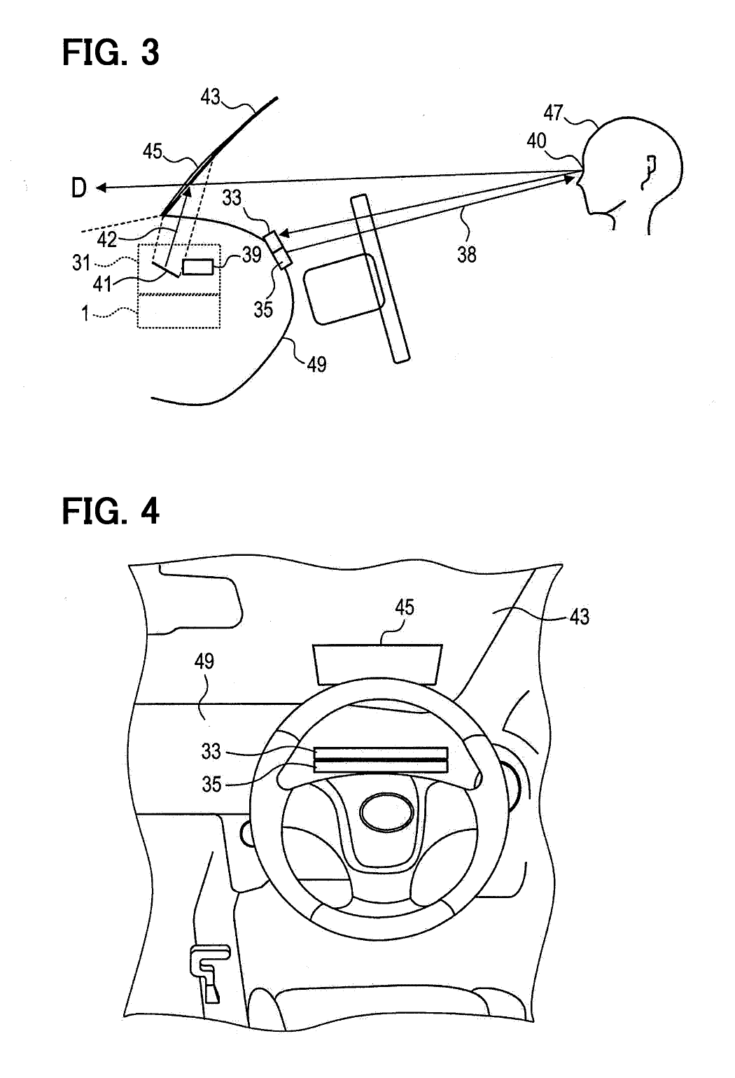

The HUD 31 has a known configuration and can display information to a driver 47 of the subject vehicle. Specifically, as shown in FIG. 3, the HUD 31 generates a light 42 displaying an image by using a light irradiated by a light source 39. The HUD 31 projects the light 42 displaying the image to a display area 45 on a windshield 43 by using a concave mirror 41. The driver 47 of the subject vehicle can view a virtual image of a display image ahead of the display area 45. The virtual image corresponds to a display. The driver 47 corresponds to a user.

The HUD 31 can display a reference display object, a comparison display object, a calibration display object and an instruction to the driver 47 or the like, explained later, by a signal received from the display correction apparatus 1. The HUD 31 becomes a target of a process performed by the display correction apparatus 1 such as correction of a tilt or distortion of the display. The detail will be explained later.

The infrared camera 33 can acquire the image in a wavelength region of infrared light. As shown in FIG. 3 and FIG. 4, the infrared camera 33 is installed to a dashboard 49 of the subject vehicle. The infrared camera 33 photographs a face of the driver 47 from a front direction. A range of the image acquired by the infrared camera 33 includes an eye 40 of the driver 47. The infrared camera 33 is controlled by the display correction apparatus 1. The infrared camera 33 outputs the acquired image to the display correction apparatus 1.

The infrared light irradiation unit 35 irradiates an infrared light beam 38 to the eye 40. The infrared light irradiation unit 35 is attached to an under side of the infrared camera 33 in the dashboard 49. From a view of the eye 40, the infrared camera 33 and the infrared light irradiation unit 35 exists in nearly same direction. The display correction apparatus 1 controls the infrared light irradiation unit 35.

A hard switch 37 is installed to a cabin of the subject vehicle. The hard switch 37 is a switch receiving an operation from the driver 47. Upon receiving the operation of the driver 47, the hard switch 37 outputs a signal corresponding to the operation to the display correction apparatus 1.

2. Process Executed by the Display Correction Apparatus 1

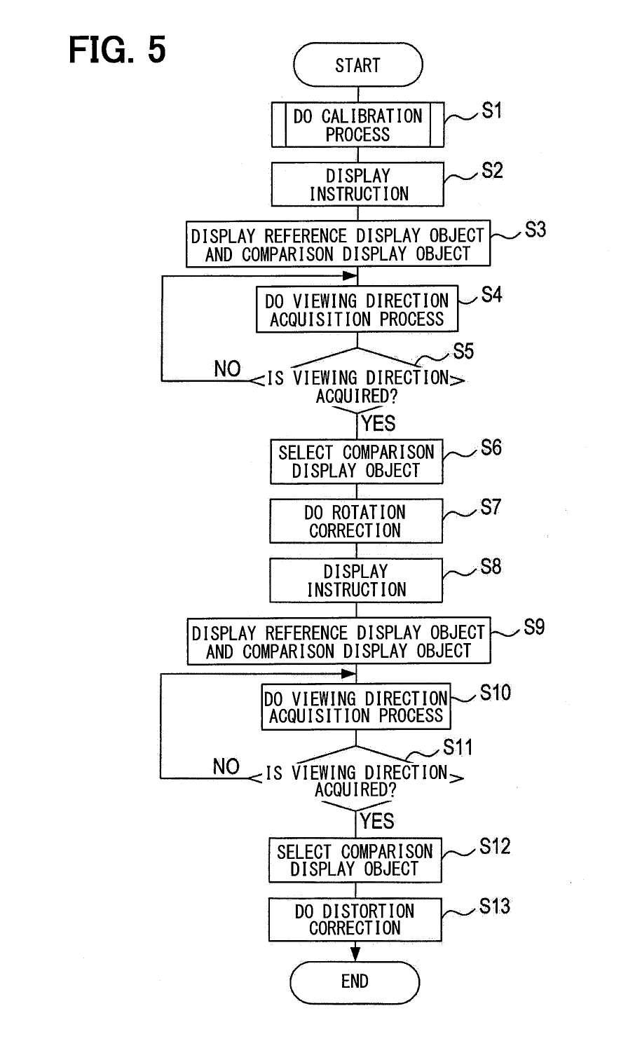

A process executed by the display correction apparatus 1 will be explained based on FIGS. 5 to 9. The process may be executed when the driver 47 makes instruction or when a source of the HUD 31 is turned on.

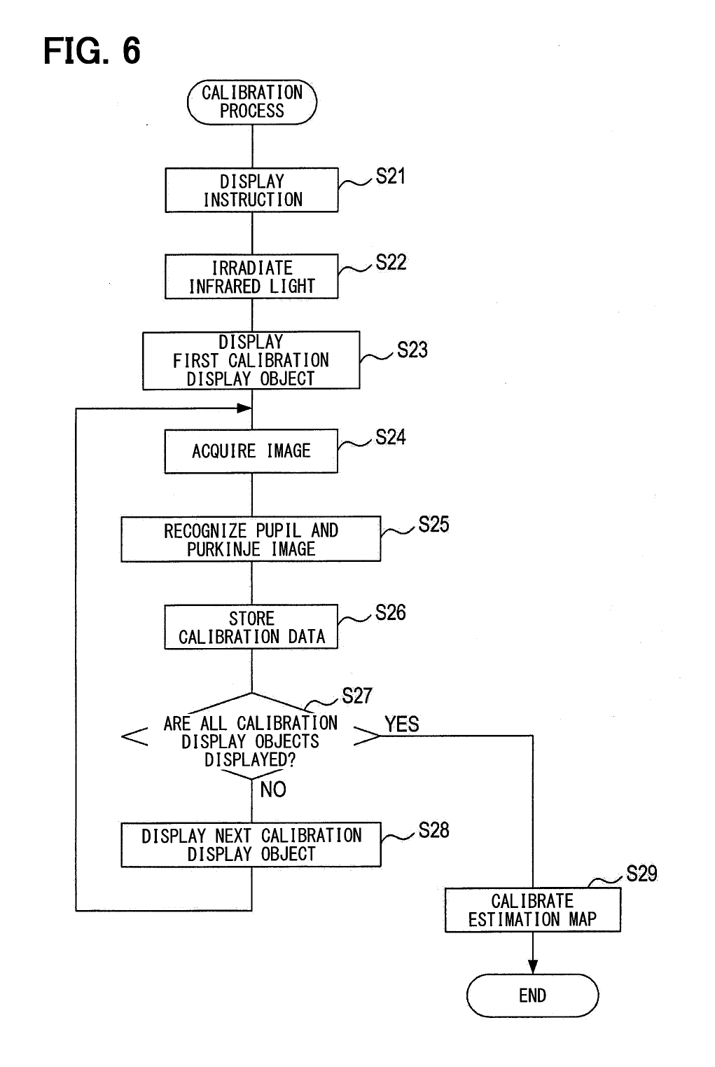

In Step 1 of FIG. 5, the calibration display unit 19 and the calibration unit 21 performs a calibration process. The calibration process will be explained by using FIG. 6. In Step 21 of FIG. 6, the calibration display unit 19 displays an instruction to the driver 47 by using the HUD 31. The instruction is a display composed of characters “In a state of viewing a point to be displayed from now on, please push a switch”.

In Step 22, the calibration unit 21 irradiates the infrared light beam 38 to the eye 40 by using the infrared light irradiation unit 35.

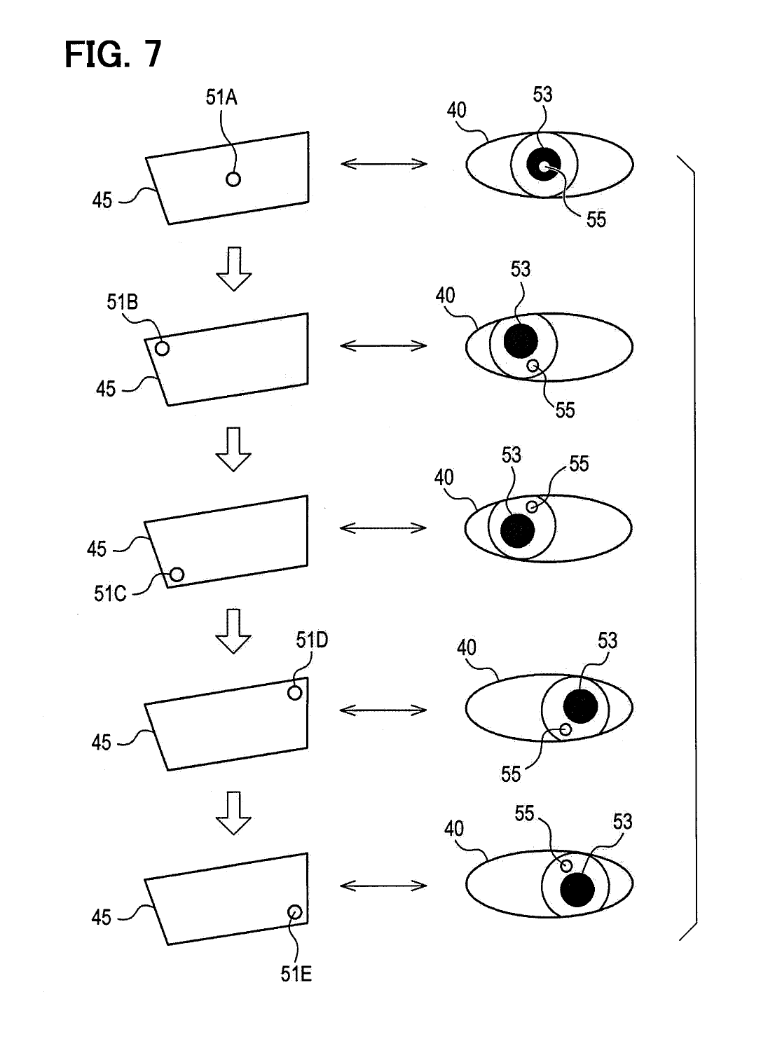

In Step 23, as shown in FIG. 7, the calibration display unit 19 displays a first calibration display object 51A by using the HUD 31. The first calibration display object 51A is a circular display object. The first calibration display object 51A is sufficiently smaller than the display area 45 and has a size can be visually recognized by the driver 47. The first calibration display object 51A is positioned in the center of the display area 45. The position of the first calibration display object 51A is a known position for the display correction apparatus 1.

In Step 24, the calibration unit 21 acquires the image in the range including the eye 40 by using the infrared camera 33 at a timing when the hard switch 37 receives an input operation. Then, since the driver 47 is viewing the first calibration display object 51A, a viewing direction D of the driver 47 is the direction from the eye 40 to the first calibration display object 51A.

In Step 25, in the image acquired in Step 24, the calibration unit 21 recognizes a pupil 53 and a Purkinje image 55 shown in FIG. 7 by a known image recognition method. The Purkinje image 55 is a reflected image on a cornea surface.

In Step 26, the calibration unit 21 stores a positional relation between the pupil 53 and the Purkinje image 55 recognized in Step 25 in the memory 5. Hereinafter, the positional relation between the pupil 53 and the Purkinje image 55 is set to be as a positional state of the eye. The positional state of the eye includes a direction of the Purkinje image 55 based on the pupil 53 and a distance from the pupil 53 to the Purkinje image 55.

The calibration unit 21 relates the viewing direction D at when the image is acquired in Step 24 with the positional state of the eye, and stores in the memory 5.

The viewing direction D at when the image has been acquired in Step 24 is the direction from the eye 40 to the first calibration display object 51A in the case that the image is acquired in Step 24 with the first calibration display object 51A displayed in the HUD 31. As explained later, in the case that the image is acquired in Step 24 in the state where another calibration display object 51 is displayed on the HUD 31, the direction is from the eye 40 to the calibration display object 51 while displayed.

Hereinafter, a combination of the positional relation of the eye and the viewing direction D related with it is set to be a calibration data.

In Step 27, the calibration unit 21 determines whether all calibration display objects are already displayed. In the case that the all calibration display objects have already been displayed, process shifts to Step 29. In the case that the all calibration display objects have not been displayed yet, process shifts to Step 28.

As shown in FIG. 7, the calibration display object includes the first calibration display object 51A, a second calibration display object 51B, a third calibration display object 51C, a fourth calibration display object 51D and a fifth calibration display object 51E. These calibration display objects may be generally referred to as the calibration display object 51, hereinafter.

All calibration display objects 51 have the same shape and the same size. The second calibration display object 51B is positioned in an upper left of the display area 45, the third calibration display object 51C is positioned in a central lower left of the display area 45, the fourth calibration display object 51D is positioned in an upper light of the display area 45 and the fifth calibration display object 51E is positioned in a lower right of the display area 45. The position of each calibration display object 51 is the known position for the display correction apparatus 1.

After the first calibration display object 51 is displayed in Step 23, every time that the process of Step 28 explained later is executed, the first calibration display object 51A, the second calibration display object 51B, the third calibration display object 51C, the fourth calibration display object 51D and the fifth calibration display object 51E are sequentially displayed. Hence, the position of the calibration display object 51 is sequentially changed. All calibration display objects 51 have already been displayed, which shows that the fifth calibration display object 51E has already been displayed.

In Step 28, the calibration display unit 19 displays a next calibration display object 51 by using the HUD 31. In the case that the calibration display object 51 displayed immediate before is the first calibration display object 51A, the next calibration display object 51 is the second calibration display object 51B. In the case that the calibration display object 51 displayed immediately before is the second calibration display object 51B, the next calibration display object 51 is the third calibration display object 51C. In the case that the calibration display object 51 displayed immediately before is the third calibration display object 51C, the next calibration display object 51 is the fourth calibration display object 51D. In the case that the calibration display object 51 displayed immediately before is the fourth calibration display object 51D, the next calibration display object 51 is the fifth calibration display object 51E. After Step 28, the process shifts to Step 24. Hence, after Step 23, until the determination becomes affirmative in Step 27, a cycle from Step 24 to Step 28 is repeated 5 times.

In the first time of the cycle, in Step 24, the image in the range including the eye 40 at when the viewing direction D is the direction from the eye 40 to the first calibration display object 51A is acquired. In addition, in the first time of the cycle, as shown in FIG. 7, in Step 25, the pupil 53 and the Purkinje image 55 at when the viewing direction D is the direction from the eye 40 to the first calibration display object 51A are recognized. In addition, in the first time of the cycle, in Step 26, the calibration data associating the viewing direction D from the eye 40 to the first calibration display object 51A with a positional relation of the eye at when the viewing direction D is stored in the memory 5.

In the second time of the cycle, in Step 24, the image in the range including the eye 40 at when the viewing direction D is the direction from the eye 40 to the second calibration display object 51B is acquired. In addition, in the second time of the cycle, as shown in FIG. 7, in Step 25, the pupil 53 and the Purkinje image 55 at when the viewing direction D is the direction from the eye 40 to the second calibration display object 51B are recognized. In addition, in the second time of the cycle, in Step 26, the calibration data associating the viewing direction D from the eye 40 to the second calibration display object 51B with a positional relation of the eye at when the viewing direction D is stored in the memory 5.

In the third time of the cycle, in Step 24, the image in the range including the eye 40 at when the viewing direction D is the direction from the eye 40 to the third calibration display object 51C is acquired. In addition, in the third time of the cycle, as shown in FIG. 7, in Step 25, the pupil 53 and the Purkinje image 55 at when the viewing direction D is the direction from the eye 40 to the third calibration display object 51C are recognized. In addition, in the third time of the cycle, in Step 26, the calibration data associating the viewing direction D from the eye 40 to the third calibration display object 51C with a positional relation of the eye at when the direction is the viewing direction D is stored in the memory 5.

In the fourth time of the cycle, in Step 24, the image in the range including the eye 40 at when the viewing direction D is the direction from the eye 40 to the fourth calibration display object 51D is acquired. In addition, in the fourth time of the cycle, as shown in FIG. 7, in Step 25, the pupil 53 and the Purkinje image 55 at when the viewing direction D is the direction from the eye 40 to the fourth calibration display object 51D are recognized. In addition, in the fourth time of the cycle, in Step 26, the calibration data associating the viewing direction D from the eye 40 to the fourth calibration display object 51D with the positional relation of the eye at when the direction is the viewing direction D is stored in the memory 5.

In the fifth time of the cycle, in Step 24, the image in the range including the eye 40 at when the viewing direction D is the direction from the eye 40 to the fifth calibration display object 51E is acquired. In addition, in the fifth time of the cycle, as shown in FIG. 7, in Step 25, the pupil 53 and the Purkinje image 55 at when the viewing direction D is the direction from the eye 40 to the fifth calibration display object 51E are recognized. In addition, in the fifth time of the cycle, in Step 26, the calibration data associating the viewing direction D from the eye 40 to the fifth calibration display object 51E with the positional relation of the eye at when the direction is the viewing direction D is stored in the memory 5.

In Step 29, the calibration unit 21 generates an estimation map regulating a relation between the positional relation of the eye and the viewing direction D by using the calibration data stored in Step 26. The estimation map outputs the viewing direction D corresponding to the positional relation of the eye when the positional relation of the eye is inputted.

A correspondence relation between the positional relation of the eye and the viewing direction D in the estimation map will be explained bellow. The positional relation of the eye included in the calibration data corresponds to the viewing direction D associated in the calibration data. In regard to the positional relation not included in the calibration data, an interpolation calculation based on the calibration data is operated, so that the corresponding viewing direction D is determined. For example, a middle positional relation of the eye between the positional relation at when viewing the first calibration display object 51A and the positional relation at when viewing the second calibration display object 51B is associated with a middle viewing direction D between the viewing direction D toward the first calibration display object 51A and the viewing direction D toward the second calibration display object 51B.

As shown in FIG. 5, in Step 2, the instruction unit 13 displays an instruction by using the HUD 31. The instruction is a display of the characters “In a state of viewing a comparison display object in the same position in a longitudinal direction as a reference display object, please push the switch”.

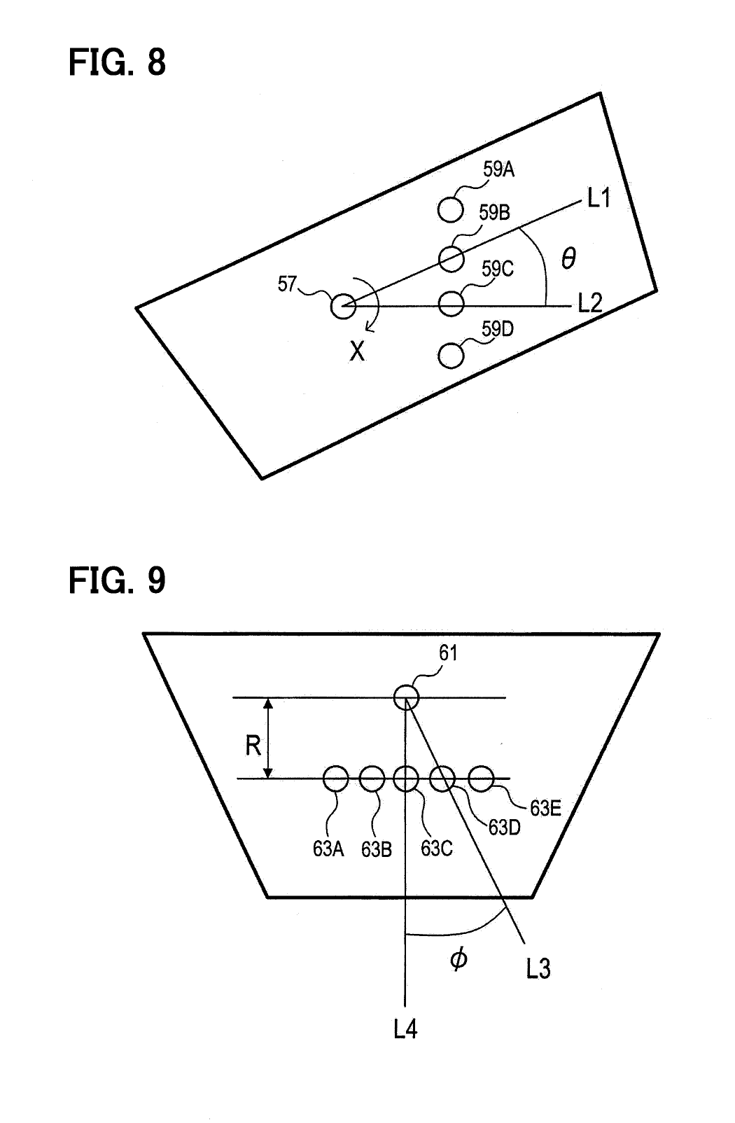

In Step 3, as shown in FIG. 8, the reference display unit 9 displays a reference display object 57 by using the HUD 31. The comparison display unit 11 displays multiple comparison display objects 59A, 59B, 59C and 59D by using the HUD 31.

The reference display object 57 and the comparison display objects 59A, 59B, 59C and 59D are circular display objects each having the same size. The size is a size that the driver 47 can view and also is sufficiently small in comparison to the display area 45. The positions in the longitudinal direction of the comparison display objects 59A, 59B, 59C and 59D are different each other. That is, the comparison display object 59A is positioned at the highest, the comparison display object 59B is positioned at the second highest, the comparison display object 59C is positioned at the third highest and the comparison display object 59D is positioned at the lowest.

When the display of the HUD 31 doesn't have the tilt and the distortion, the positions in the longitudinal direction of the comparison display object 59B and the reference display object 57 are same. The comparison display object 59B corresponds to a specific display object. The comparison display objects 59A, 59B, 59C and 59D are arranged along a vertical direction. The positions in the transverse direction of the comparison display objects 59A, 59B, 59C and 59D are different from the position in the transverse direction of the reference display object 57.

In Step 4, the viewing acquisition unit 7 acquires the viewing direction D. The light irradiation unit 23 irradiates the infrared light beam 38 to the eye 40 by using the infrared light irradiation unit 35. Next, the image acquisition unit 25 acquires the image including the eye 40 by using the infrared camera 33 at the timing when the hard switch 37 receives the input operation. The driver 47 views one of the comparison display objects 59A, 59B, 59C and 59D at the same position in the longitudinal direction as the reference display object 57. Therefore, the viewing direction D of the driver 47 is the direction from the eye 40 to the one of the comparison display objects 59A, 59B, 59C and 59D at the same position in the longitudinal direction as the reference display object 57.

Next, the recognition unit 27 recognizes the pupil 53 and the Purkinje image 55 in the image acquired like above by the known image recognition method and acquires the positional relation of the eye. Next, the estimation unit 29 inputs the positional relation of the eye acquired like above to the estimation map generated in the calibration process of Step 1 and acquires the viewing direction D.

In Step 5, the viewing acquisition unit 7 determines whether the viewing direction D is acquired in Step 4. In the case that the viewing direction D has been acquired, the process shifts to Step 6. In the case that the viewing direction D has not been acquired, the process returns to Step 4.

In Step 6, the selection unit 15 selects the comparison display object in the viewing direction D acquired in Step 4 from the comparison display objects 59A, 59B, 59C and 59D. Hereinafter, the comparison display object selected by the selection unit 15 is set to be a selection comparison display object. In an example of FIG. 8, the comparison display object 59C is the selection comparison display object.

In Step 7, the correction unit 17 performs a rotation correction as bellow. A straight line passing through the reference display object 57 and the comparison display object 59B is set to be a straight line L1. The comparison display object 59B corresponds to the specific display object, as mentioned above. The straight line passing through the reference display object 57 and the comparison display object 59C is set to be a straight line L2. The comparison display object 59C is the selection comparison display object. Next, an angle θ between the straight line L1 and the straight line L2 is calculated. The angle θ corresponds to magnitude of the tilt of the display in the HUD 31.

Next, the correction that the display of the HUD 31 is rotated in a direction that the comparison display object 59B approaches the position of the comparison display object 59C before the correction by only the angle 0. In the example shown in FIG. 8, the correction that causes to rotate in the direction of an arrow sigh X is performed. The position in the longitudinal direction of the comparison display object 59B after the correction accords with the position in the longitudinal direction of the comparison display object 59C before the correction.

In Step 8, the instruction unit 13 displays the instruction by using the HUD 31. The instruction is a display of characters “In a state of viewing a comparison display object in the same position in the transverse direction as the reference display object, please push a switch”.

In Step 9, as shown in FIG. 9, the reference display unit 9 displays a reference display object 61 by using the HUD 31. The comparison display unit 11 shows multiple comparison display objects 63A, 63B, 63C, 63D and 63E by using the HUD 31.

The reference display object 61 and the comparison display objects 63A, 63B, 63C, 63D and 63E are circular display objects each having the same size. The size is a size that the driver 47 can view and also is sufficiently small in comparison to the display area 45. The positions in the transverse direction of the comparison display objects 63A, 63B, 63C, 63D and 63E are different each other. That is, the comparison display object 63A is positioned at the leftmost, the comparison display object 63B is positioned at the second leftmost, the comparison display object 63C is positioned at the third leftmost, the comparison display object 63D is positioned at the fourth leftmost and the comparison display object 63E is positioned at the rightmost.

When the display of the HUD 31 doesn't have the tilt and the distortion, the positions in the transverse direction of the comparison display object 63D and the reference display object 61 are same. The comparison display object 63D corresponds to a specific display object. The comparison display objects 63A, 63B, 63C, 63D and 63E are arranged along a horizontal direction. The positions in the longitudinal direction of the comparison display objects 63A, 63B, 63C, 63D and 63E are different from the position in the longitudinal direction of the reference display object 61, and there is a distance R therebetween.

In Step 10, the viewing acquisition unit 7 acquires the viewing direction D. The light irradiation unit 23 irradiates the infrared light beam 38 to the eye 40 by using the infrared light irradiation unit 35. Next, the image acquisition unit 25 acquires the image including the eye 40 by using the infrared camera 33 at the timing that the hard switch 37 receives the input operation. The driver 47 views one of the comparison display objects 63A, 63B, 63C, 63D and 63E at the same position in the transverse direction as the reference display object 61. Therefore, the viewing direction D of the driver 47 is the direction from the eye 40 to the one of the comparison display objects 63A, 63B, 63C, 63D and 63E at the same position in the transverse direction as the reference display object 61.

Next, the recognition unit 27 recognizes the pupil 53 and the Purkinje image 55 in the image acquired like above by the known image recognition method and acquires the positional relation of the eye. Next, the estimation unit 29 inputs the positional relation of the eye acquired like above to the estimation map generated in the calibration process of Step 1, and acquires the viewing direction D.

In Step 11, the viewing acquisition unit 7 determines whether the viewing direction D is acquired in Step 10. In the case that the viewing direction D has been acquired, the process shifts to Step 12. In the case that the viewing direction D has not been acquired, the process returns to Step 10.

In Step 12, the selection unit 15 selects the comparison display object in the viewing direction D acquired in Step 10 from the comparison display objects 63A, 63B, 63C, 63D and 63E. In an example of FIG. 9, the comparison display object 63C is the selection comparison display object.

In Step 13, the correction unit 17 performs a distortion correction. A straight line passing through the reference display object 61 and the comparison display object 63D is set to be a straight line L3. The comparison display object 63D corresponds to the specific display object. The straight line passing through the reference display object 61 and the comparison display object 63C is set to be a straight line L4. The comparison display object 63C is selection comparison display object. Next, an angle ϕ between the straight line L3 and the straight line L4 is calculated. The angle ϕ corresponds to the magnitude of the distortion in the transverse direction of the display in the HUD 31.

Next, the correction to eliminate the distortion in the transverse direction is performed to the display of the HUD 31. For example, the correction to perform the elimination of the distortion in the transverse direction is the correction comparing an upper display in the display area 45 with a lower display in the display area 45 and elongating or contracting in the transverse direction. The correction is the correction that the comparison display object 63D approaches the position of the comparison display object 63C before correction. The position in the transverse direction of the comparison display object 63D after the correction accords with the position in the transvers direction of the comparison display object 63C before the correction.

3. Effects Provided by the Display Correction Apparatus 1

(1A) With the display correction apparatus 1, it may be possible for the driver 47 to easily correct the tilt and the distortion of the display of the HUD 31.

(1B) It may be possible that the display correction apparatus 1 performs the correction by acquiring the viewing direction D and using the viewing direction D. Therefore, the driver 47 may not correct by manual operation. The display correction apparatus 1 may be possible to perform the correction while keeping the position of the eye 40 at a position in driving the subject vehicle. That is, the position of the eye 40 is unchanged in correcting and driving of the subject vehicle. It may be possible to more accurately perform the correction.

(1C) The display correction apparatus 1 recognizes the pupil 53 and Purkinje image 55 in the image obtained by photographing the eye 40, and acquires the positional relation of the eye 40. The display correction apparatus 1 estimates the viewing direction D by using the positional relation of the eye. Consequently, it may be possible to more accurately acquire the viewing direction D.

(1D) The display correction apparatus 1 performs the calibration of the viewing acquisition unit 7 so that the calibration display object 51 exists in the viewing direction D acquired at the time that the calibration display object 51 is displayed. It may be possible to more accurately acquire the viewing direction D.

(1E) The display correction apparatus 1 sequentially changes the positions of the calibration display object 51 and performs the calibration to acquire the viewing direction D by using the calibration display object 51 displayed in each display position. It may be possible to more accurately acquire the viewing direction D.

(1F) The display correction apparatus 1 may be possible to correct the tilt and the distortion of the display each.

### Second Embodiment

1. Difference from the First Embodiment

Since a basic configuration of a second embodiment is similar to the first embodiment, the explanation with respect to the common configuration will be omitted and a difference will be mainly explained. An identical reference with the first embodiment shows the same configuration and refers to a preceding explanation.

In Step 8, the instruction unit 13 displays the instruction by using the

HUD 31. The instruction is a display of the characters “In a state of viewing a comparison display object in the same position in a longitudinal direction as the reference display object, please push a switch”.

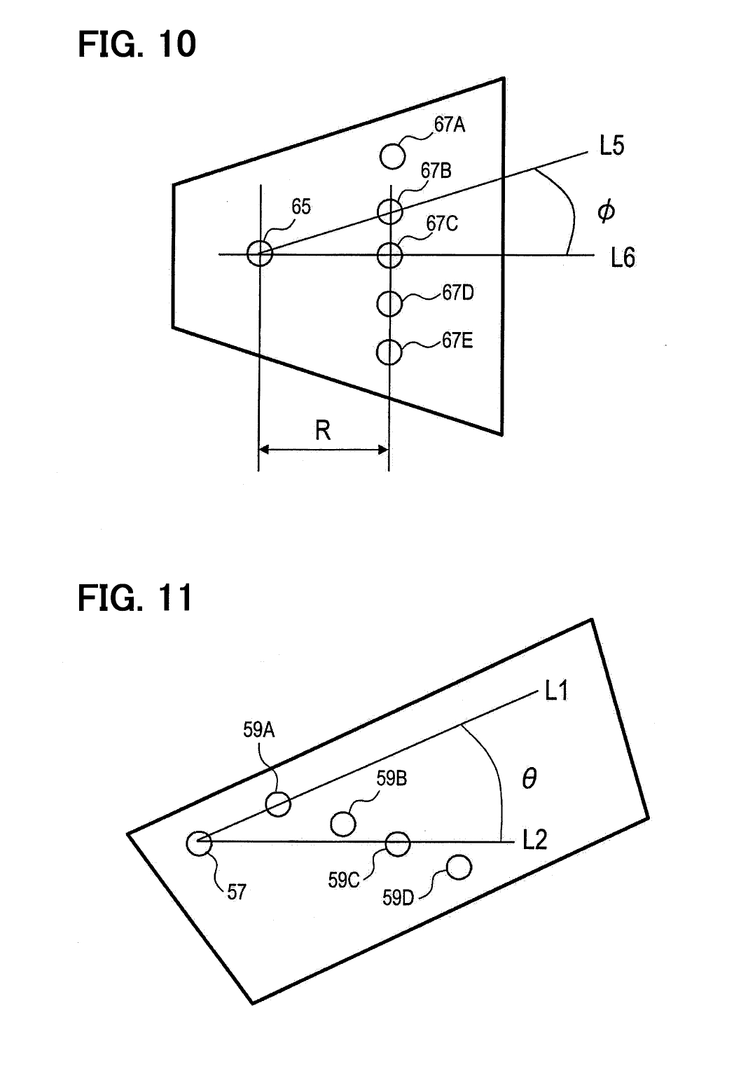

In Step 9, as shown in FIG. 10, the reference display unit 9 displays a reference display object 65 by using the HUD 31. The comparison display unit 11 displays multiple comparison display objects 67A, 67B, 67C, 67D and 67E by using the HUD 31.

The reference display object 65 and the comparison display objects 67A, 67B, 67C, 67D and 67E are circular display objects each having the same size. The size is a size that the driver 47 can view and also is sufficiently small in comparison with the display area 45. The positions in the longitudinal direction of the comparison display objects 67A, 67B, 67C, 67D and 67E are different each other. That is, the comparison display object 67A is positioned at the highest, the comparison display object 67B is positioned at the second highest, the comparison display object 67C is positioned at the third highest, the comparison display object 67D is positioned at the fourth highest and the comparison display object 67E is positioned at the lowest.

When the display of the HUD 31 doesn't have the tilt and the distortion, the positions in the longitudinal direction of the comparison display object 67B and the reference display object 65 are same. The comparison display object 67B corresponds to a specific display object. The comparison display objects 67A, 67B, 67C, 67D and 67E are arranged along the vertical direction. The positions in the transverse direction of the comparison display objects 67A, 67B, 67C, 67D and 67E are different from the position in the transverse direction of the reference display object 65, and there is a distance R therebetween.

The process of Step 10 to Step 12 is similar to the first embodiment.

In Step 13, the correction unit 17 performs a distortion correction. A straight line passing through the reference display object 65 and the comparison display object 67B is set to be a straight line L5. The comparison display object 67B corresponds to the specific display object. The straight line passing through the reference display object 65 and the comparison display object 67C is set to be a straight line L6. The comparison display object 67C is selection comparison display object. Next, an angle ϕ between the straight line L5 and the straight line L6 is calculated. The angle ϕ corresponds to the magnitude of the distortion in the longitudinal direction of the display in the HUD 31.

Next, the correction to eliminate the distortion in the longitudinal direction is performed to the display of the HUD 31. For example, the correction to eliminate the distortion in the longitudinal direction is the correction comparing the display in the right side of the display area 45 with the display in the left side of the display area 45 and elongating or contracting in the longitudinal direction. The correction is the correction that the comparison display object 67B approaches the position of the comparison display object 67C before correction. The position in the longitudinal direction of the comparison display object 67B after the correction accords with the position in the longitudinal direction of the comparison display object 67C before corrected.

2. Effects Provided by the Display Correction Apparatus 1

According the second embodiment, it may be possible to achieve the effects of the first embodiment.

### Other Embodiments

Another embodiment will be exemplified.

(1) According to the first embodiment and the second embodiment, as shown in FIG. 11, the position in the transverse direction of the comparison display objects 59A, 59B, 59C and 59D may be different each other. In this case, it may be possible to decrease a space in the longitudinal direction of the comparison display objects 59A, 59B, 59C and 59D. Consequently, it may be possible to more precisely detect the tilt of the display. The transverse direction corresponds to a direction orthogonal to the longitudinal direction.

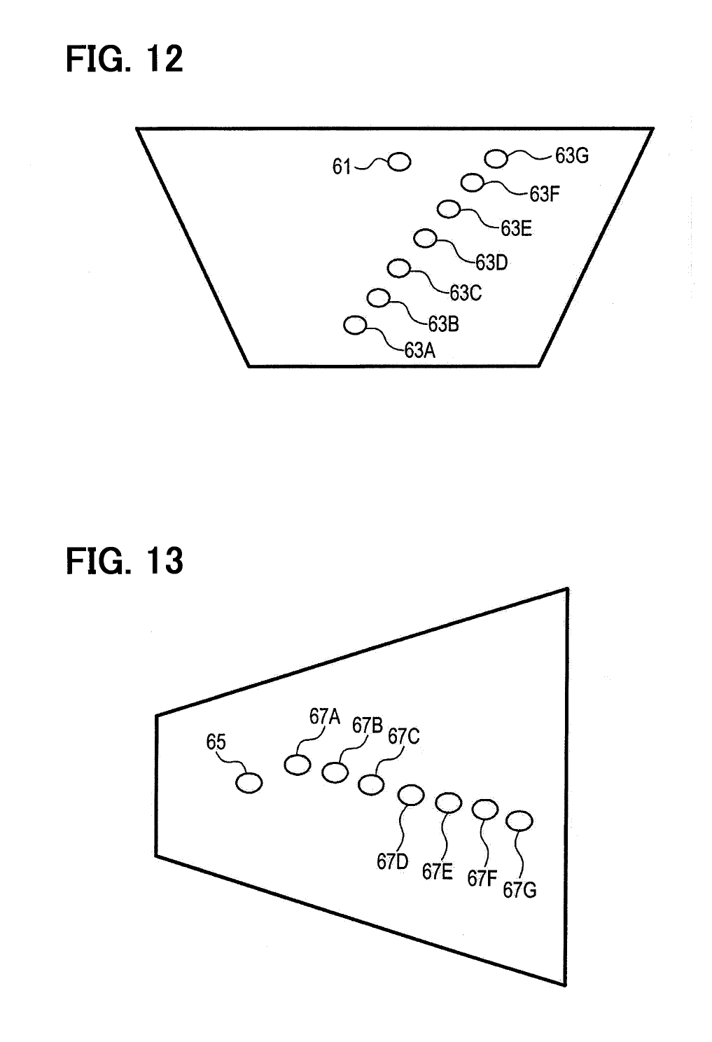

(2) In the first embodiment, as shown in FIG. 12, the positions in the longitudinal direction of the comparison display objects 63A, 63B, 63C, 63D, 63E, 63F and 63G may be different each other. In this case, it may be possible to decrease a space in the transverse direction of the comparison display objects 63A, 63B, 63C, 63D, 63E, 63F and 63G. Consequently, it may be possible to more precisely detect the distortion in the transverse direction of the display.

(3) In the second embodiment, as shown in FIG. 13, the positions in the transverse direction of the comparison display objects 67A, 67B, 67C, 67D, 67E, 67F and 67G may be different each other. In this case, it may be possible to decrease a space in the longitudinal direction of the comparison display objects 67A, 67B, 67C, 67D, 67E, 67F and 67G. Consequently, it may be possible to more precisely detect the distortion in the longitudinal direction of the display.

(4) A target corrected by the display correction apparatus 1 may be a display apparatus except for the HUD 31. For example, a target corrected by the display correction apparatus 1 may be a liquid crystal display, an organic EL display or the like. The display apparatus may be the display apparatus except for the onboard apparatus.

(5) The method that the display correction apparatus 1 acquires a viewing direction D may be another way and be possible to be appropriately selected from a known method.

(6) It may be possible to appropriately set modes of the reference display object and the comparison display object. For example, the modes of the reference display object and the comparison display object may be set as a rectangle, a triangle, an X mark, a numeric character, a character and a straight line, or the like.

(7) The display correction apparatus 1 may not execute the calibration process of Step 1. In this case, the display correction apparatus 1 may be possible to include a standard estimation map.

(8) In the first embodiment and the second embodiment, in Step 4, when the driver 47 continuously views in the same direction for a predetermined period of time or longer, the image including the eye 40 may be possible to be acquired. It is also similar in Step 10.

(9) In the first embodiment and the second embodiment, the display correction apparatus 1 may perform correction in accordance with the viewing direction D of an occupant except for the driver 47.

(10) A function that one configuration element according to the embodiment has may be dispersed or a function that multiple configuration elements have may be integrated into one configuration element. The configurations of the embodiment may be omitted partially. At least one part of the configuration of the embodiment may be added or substituted to another embodiment.

(11) Except for the display correction apparatus, various embodiments may be possible to include the system setting the display correction apparatus as a configuration element, the program to function the computer as the controller of the display configuration apparatus, the non-transitory tangible storage medium such as the semiconductor memory storing the program, a correction method of the display configuration apparatus or the like.

What is claimed is:

1. A display correction apparatus that corrects a tilt and/or a distortion of a display in a display apparatus, the display correction apparatus comprising:
a viewing acquisition unit that acquires a viewing direction of a user;
a reference display unit that displays a reference display object in the display apparatus;
a comparison display unit that displays a plurality of comparison display objects differently positioned each other in one direction either of a longitudinal direction or a transverse direction, wherein the comparison display objects include a specific display object that is positioned in a same position as the reference display object in the one direction when the tilt and/or the distortion does not exist;
an instruction unit that instructs the user to view a particular comparison display object of the comparison display objects that is positioned in a same position in the one direction as the reference display object;
a selection unit that selects from the comparison display objects, a comparison display object existing in the viewing direction acquired by the viewing acquisition unit, when the instruction unit performs instruction; and
a correction unit that corrects the display so that a position of the specific display object becomes a position of the comparison display object selected by the selection unit in the one direction.

2. The display correction apparatus according to claim 1, wherein:
the viewing acquisition unit includes
a light irradiation unit that irradiates a light to an eye of the user,
an image acquisition unit that acquires an image of a range including the eye of the user,
a recognition unit that recognizes a pupil and a Purkinje image from the image acquired by the image acquisition unit, and
an estimation unit that estimates the viewing direction based on a positional relation between the pupil and the Purkinje image recognized by the recognition unit.

3. The display correction apparatus according to claim 1, further comprising:
a calibration display unit that displays a calibration display object at a known position in a display area of the display apparatus; and
a calibration unit that performs a calibration of the viewing acquisition unit so that the calibration display object exists in the viewing direction acquired by the viewing acquisition unit when the calibration display object is displayed.

4. The display correction apparatus according to claim 3, wherein:
the calibration display unit is configured to sequentially change display positions of the calibration display object; and
the calibration unit performs the calibration by using the calibration display object displayed in each of the display positions.

5. The display correction apparatus according to claim 1, wherein:
the comparison display unit is configured so that the plurality of the comparison display objects are differently positioned each other in a direction orthogonal to the one direction.

6. The display correction apparatus according to claim 1, wherein:
the correction unit corrects the display by rotating the display.

7. The display correction apparatus according to claim 1, wherein:
the correction unit performs a distortion correction of the display.
